(19) United States
(12) Patent Application Publication
(10) Pub. No.: US 2026/0180059 A1
(43) Pub. Date: Jun. 25, 2026

(54) Energy Storage Cell, Energy Storage Device, Motor Vehicle, and Method for Producing an Energy Storage Cell

(71) Applicant: Bayerische Motoren Werke Aktiengesellschaft, Muenchen (DE)

(72) Inventor: Robert ALIG, Germering (DE)

(21) Appl. No.: 18/854,757

(22) PCT Filed: Apr. 4, 2023
(86) PCT No.: PCT/EP2023/058870

§ 371 Date: Oct. 7, 2024

(30) Foreign Application Priority Data
Apr. 20, 2022 (DE) 10 2022 109 570.3

(51) Int. Cl. H01M 10/613; B60L 50/64; H01M 10/0525; H01M 10/643; H01M 10/6555; H01M 10/6568; H01M 10/658; H01M 50/209

(52) U.S. Cl. CPC H01M 10/613; B60L 50/64; H01M 10/0525; H01M 10/643; H01M 10/6555; H01M 10/6568; H01M 10/658; H01M 50/209

(57) ABSTRACT

An energy storage cell for a motor vehicle energy storage device includes a storage cell housing which defines an inner region, an electrode assembly, an electrolyte in the inner region, and an at least partly elastic insulating sleeve on an outer circumferential surface of the storage cell housing. The insulating sleeve at least partly surrounds the storage cell housing and contains at least one cavity. Also described is an energy storage device including the energy storage cell, a motor vehicle, and a method for producing the energy storage cell.

### BACKGROUND AND SUMMARY

The present invention relates to an energy storage cell for a motor vehicle energy storage device, to an energy storage device comprising a plurality of such energy storage cells, to a motor vehicle comprising the energy storage device and to a method for producing an energy storage cell.

Modern energy storage cells such as lithium ion accumulators (lithium ion secondary batteries) generally have an electrode assembly with an anode, a cathode and a separator arranged between the anode and the cathode, the electrode assembly being arranged together with an electrolyte in a housing of the energy storage cell. The anode and cathode comprise a respective electrode, normally a metallic electrode (copper, for example, on the anode side; aluminum, for example, on the cathode side), which is coated with an active material (graphite, for example, on the anode side; lithium cobalt oxide or lithium manganese oxide, for example, on the cathode side). The housing, which is also referred to as a “can” in the case of cylindrical energy storage cells, may have an insulation layer on the outside. The separator is intended to be permeable only for lithium ions, but in other regards to insulate the anode electrically from the cathode.

Both during production and over the further service life of such energy storage cells, lithium metal may be deposited as sponge or dendrite on the anode (so-called “lithium plating”), in particular during fast charging processes. In order to reduce the deposition of lithium, it is known from the prior art to subject the positive and/or negative electrode of a lithium cell to a corona treatment. In this regard, for example, the document DE 10 2014 218 143 A1 discloses a method for producing a lithium cell, in which a particulate active material and a coating compound containing a binder are applied onto a metal foil in order to form a positive and/or negative electrode. The respective electrode is subsequently pressed.

After the separator has been introduced between the electrodes, a liquid electrolyte is added in a housing. Before wetting with the liquid electrolyte, the positive and/or negative electrode is subjected to a corona treatment so that the liquid electrolyte penetrates into the pores of the electrode.

Against this background, it is an object of the present disclosure to provide an energy storage cell which is suitable for a motor vehicle energy storage device, can be produced efficiently and is distinguished by a relatively long service life. It is furthermore an object of the present disclosure to provide a corresponding energy storage device, a corresponding motor vehicle and a corresponding method for producing an energy storage cell.

This object may be achieved by an energy storage cell according to the independent claim(s), and by an energy storage device, a motor vehicle, and a method for producing an energy storage cell having the features of the independent claim(s).

The energy storage cell, which is intended for installation in a motor vehicle energy storage device, comprises a storage cell housing defining an inner region, an electrode assembly as well as an electrolyte in the inner region and, on an outer circumferential surface of the storage cell housing, an insulating sleeve which behaves elastically at least in sections and surrounds the storage cell housing at least in sections. At least one cavity is formed in the insulating sleeve.

During charging and over the service life of the energy storage cell, the insulating sleeve of this energy storage cell allows the electrode assembly and the storage cell housing to expand elastically and while adapting the size of the cavity, and to contract again. The lithium deposition mentioned in the introduction and other mechanical, thermal and/or chemical effects may lead to a volume change of the active material and therefore to a dynamic size change of the storage cell housing. This size change may take place cyclically over charging/discharging cycles, and the size of the storage cell housing may additionally increase over the service life. A size increase may be caused by gas formation in the inner region. In the installation position of the energy storage cell in the motor vehicle energy storage device, the cavity can serve as a buffer space for volume compensation, in particular to absorb a volume increase of the widening storage cell housing. The content of the storage cell housing may thus be provided with more space in the energy storage device. Accordingly, lithium dendrites formed for instance during a fast charging process may have more space available in the energy storage device, with the result that the energy storage cell can be durable. At the same time, the energy storage device may be configured comparatively efficiently in terms of installation space.

Owing to its stiffness, furthermore, the insulating sleeve can counteract the expansion of the housing and distribute gas formed in the inner region better over the inner region. The pressure distribution on the electrode assembly can be comparatively homogeneous. This may synergistically make it possible that less lithium is deposited even during fast charging processes, so that the energy storage cell can age comparatively slowly. Consequently, the high current-carrying capacity and cycle stability of these energy storage cells may also be improved relatively straightforwardly. In addition, a corona treatment of the energy storage cell may be obviated.

The energy storage cell may be configured cylindrically (as a so-called round cell) or prismatically. Preferably, the energy storage cell therefore has at least one main extent direction. This is the direction in which the energy storage cell has the longest dimension (length). This main extent direction is also described below as axial. While the main extent direction of a cylindrical energy storage cell is the cylinder axis, the main extent direction of a prismatic energy storage cell may in particular run parallel to a main (side) surface or central main plane of this energy storage cell. Correspondingly, the term radial describes a direction perpendicular to the main extent direction and/or perpendicular to the outer circumferential surface of the storage cell housing.

The electrode assembly is preferably wound, although it may alternatively be stacked. If the energy storage cell is a round cell, the storage cell housing may be cylindrical (“cell can”). When the operationally induced expansion explained above of the active materials in the inner region of the round cell takes place, the housing experiences a tensile stress in the circumferential region. Advantageously, comparatively thin housing cross sections together with the insulating sleeve can therefore compensate for the forces that result from the swelling. The storage cell housing is preferentially conductive, in particular metallic, and preferably comprises aluminum, steel or a steel alloy.

The electrode assembly may be provided with an anode, a cathode and a separator between the anode and the cathode. The energy storage cell is preferably a lithium ion secondary battery (so-called lithium ion accumulator). That is to say, the anode and the cathode each preferably comprise a metallic electrode (copper, for example, on the anode side; aluminum, for example, on the cathode side) which can be coated with an active material (graphite, for example, on the anode side; lithium cobalt oxide or lithium manganese oxide, for example, on the cathode side). The separator is preferably permeable only for lithium ions but not for electrons. The electrolyte is preferably liquid; it may alternatively be solid. The insulating sleeve may be more flexible than the storage cell housing. It may externally surround the storage cell housing in sections or fully, and is preferably an insulator (nonconductor). The insulating sleeve may correspondingly have an electrical conductivity of less than 10⁻⁸ S/m or less 10⁻¹⁰ S/m.

It has been mentioned that at least one cavity (that is to say one cavity or a plurality of cavities) is formed in the insulating sleeve. A geometry of the cavity may be round, in particular spherical or ellipsoidal, or rectangular, in particular cuboid. Corners/edges of the cavity may be rounded in order to avoid cracks in the insulating sleeve during the expansion of the storage cell housing. The cavity may be filled with a fluid, in particular air or a different gas. The number of these cavities may be at least 3, at least 5 or at least 10.

The cavities (or some of the cavities) may be equal in size and/or different in size when the insulating sleeve is in its initial state, in which it is neither deformed nor stressed. An axial length of each cavity may be between 1% and 40%, preferably between 2% and 30% of the axial length of the energy storage cell. A volume occupied by all the cavities in total may preferentially be at least 70% or between 60% and 95% of the total volume of the insulating sleeve. In addition, the cavities may be distributed at equal distances over the insulating sleeve in the initial state in order to be able to provide uniform absorption of the expansion of the storage cell housing. Comments made below for the at least one cavity may apply similarly for any cavity or any subset of cavities. That is to say, the expression “the at least one cavity” may be synonymous with the expression “the cavity or the plurality of cavities.”

The at least one cavity is intended to absorb an expansion of the storage cell housing at least partially. Advantageously, the at least one cavity may thus be adapted to shrink when the storage cell housing expands. When the energy storage cell is in its installation position in the energy storage device, in which the energy storage cell occupies a predetermined fixed installation space assigned to it, an enlargement (swelling) of the storage cell housing may entail a contraction of the at least one cavity. Therefore, with a preestablished volume of space occupied by the energy storage cell, the at least one cavity allows expansion of the storage cell housing and of the inner region thereby defined with a contraction of the (internal) volume of the at least one cavity. The at least one cavity may be open radially outward to an outer circumferential surface of the insulating sleeve. Preferentially, however, the at least one cavity is contained in the insulating sleeve, i.e. enclosed (macroscopically) by the material of the insulating sleeve. The material of the insulating sleeve may in this case be gas-permeable, as explained in more detail below.

The insulating sleeve is preferably configured with multiple layers. In this case, the at least one cavity is preferably formed between at least two of the layers. The insulating sleeve may have a first layer on an outer side of the insulating sleeve, facing away from the inner region, and a second layer on an inner side of the insulating sleeve facing toward the inner region. The first and/or the second layer may extend along the entire outer circumferential surface of the storage cell housing in order advantageously to insulate the latter. In particular, the second layer may be formed directly or indirectly on the entire outer circumferential surface. The term outer circumferential surface may in this case describe the lateral surface of the storage cell housing in the circumferential direction. Additionally, the second layer may be formed (directly or indirectly) on one or both axial end surfaces (so-called front surfaces) of the storage cell housing. When the insulating sleeve has more than two layers, the cavities are preferably formed between two adjacent layers.

The at least one cavity may be bounded by the first layer and/or the second layer. Furthermore, the first layer may be connected to the second layer by means of at least one preferably flexible (connecting) web. In this case, the at least one cavity is preferably bounded by the at least one web. When at least two webs are provided, the two webs (together with the first layer and the second layer) may bound the cavity. When the insulating sleeve has a plurality of cavities, these cavities may be delimited axially from one another respectively by at least one web. When, in addition, a plurality of cavities are formed in the circumferential direction, these may likewise be delimited from one another respectively by at least one web. Overall, the cavities may therefore be arranged according to a predetermined pattern or layout along the outer circumferential surface of the storage cell housing. The layout may be regular, so that the cavities may be arranged at regular intervals. This makes it possible to absorb the radial force due to the expansion of the storage cell housing uniformly in the insulating sleeve.

The at least one web may be configured as a stiffening element, and in particular so as to be stiffer in the radial direction than the first layer and/or the second layer. For this purpose, the at least one web may be produced from a first material that is stiffer than a second material, from which at least one of the layers, in particular the first and/or the second layer, is produced. It is also conceivable to produce the first layer, the second layer and/or the webs from the same material. The at least one web may be configured to be substantially flat or curved, in particular concave.

When the insulating sleeve is provided with a plurality of cavities, a first of these cavities may be arranged adjacent to a middle of the energy storage cell and a second of these cavities may be arranged on an edge or at an end of the insulating sleeve, in particular on an axial edge or at an end of the insulating sleeve. When the energy storage cell is a cylindrical cell, for example, the first cavity may be arranged centrally with respect to the axis of the energy storage cell and the second cavity may be arranged on an axial end of the energy storage cell.

In one preferred embodiment, the first cavity and the second cavity are already different in size when the insulating sleeve is in its unstressed initial state. Preferably, the first cavity is axially and/or radially shorter than the second cavity. Further cavities, which may be larger than the first cavity and smaller than the second cavity, may be provided between the first cavity and the second cavity. Further webs may be arranged between these cavities. This configuration makes it possible to counteract the expansion of the storage cell housing more strongly axially in the middle than axially on the edge side. Since, owing to the size proportions of the first cavity and the second cavity, the storage cell housing has less room available for expansion axially in the middle of the energy storage cell than at the axial ends, gases formed in the inner region during the production of the energy storage device or during a subsequent charging process may be distributed effectively over the inner region.

The insulating sleeve is preferably connected to the storage cell housing (that is to say joined to the storage cell housing) with a force fit and/or cohesively. In the case of force-fit connection, the insulating sleeve may for example be fitted onto the storage cell housing and/or (nondestructively) removable from the storage cell housing. In the case of cohesive connection, the insulating sleeve may for example be vulcanized or adhesively bonded on the storage cell housing. The aforementioned connection may extend over the entire outer circumferential surface. That is to say, both in the case of force-fit connection and in the case of cohesive connection, as described above the insulating sleeve may be in connecting contact with the storage cell housing surface-wide (with its entire inner circumferential surface that faces toward the storage cell housing). The inner circumferential surface of the insulating sleeve may bear flat on the outer circumferential surface of the storage cell housing. In a radial cross section through the storage cell housing and the insulating sleeve, a contour of the storage cell housing may follow a contour of the insulating sleeve.

The insulating sleeve may be configured as a sleeve body (so-called cuff). Such a sleeve body in the context of the present disclosure describes an intrinsically geometrically stable three-dimensional body. A simple insulating layer on the storage cell housing therefore does not constitute a sleeve body in the present case for lack of geometrical/inherent stability. The insulating sleeve, or the sleeve body, preferably has a (radial) thickness of at least 3 mm or at least 4.5 mm or at least 6 mm. In relation to the thickness of the storage cell housing, the insulating sleeve/sleeve body is preferably at least 2 times or at least 3 times as thick radially. These dimensional specifications preferably relate to the unstressed initial state of the sleeve body. A compartment, in which the storage cell housing can be accommodated, is preferably formed in such a sleeve body. In order to produce a force fit between the insulating sleeve and the storage cell housing, the compartment may be smaller than the storage cell housing when the insulating sleeve is separated from the storage cell housing. When the storage cell housing is introduced into the compartment, the insulating sleeve is in this case preferably prestressed radially.

The insulating sleeve, in particular the first layer and/or the second layer, are preferably fluid-permeable, for example not gastight, at least in sections. In this way, a fluid (in particular gas) can escape from the at least one cavity through the material of the insulating sleeve into the environment of the energy storage cell when the storage cell housing expands and the at least one cavity shrinks. When the at least one cavity is filled with gas, it may be formed as a gas pocket. The respective at least one cavity/the at least one gas pocket may in particular be connected by at least one respective opening to the environment of the energy storage cell (in the inner space of the storage device) in order to provide pressure compensation during the compression of the insulating sleeve/during the shrinking of the at least one cavity. Alternatively, the insulating sleeve may be produced from a fluid-tight material. In this case, the at least one cavity may be filled with a compressible fluid, in particular a gas. The insulating sleeve, the first layer and/or the second layer may each be produced at least in sections from an elastomer, a thermoplastic elastomer, a (vulcanized) rubber or a chloroprene rubber. The insulating sleeve 30 may in addition be configured without joints (monolithically; “from one block”).

An energy storage device as proposed here is intended for installation in a motor vehicle. The (motor-vehicle) energy storage device may in particular be a drive battery for the motor vehicle. The energy storage device comprises a storage device housing and a plurality of energy storage cells as described in detail above for the electrochemical storage of energy. The energy storage cells are, in particular, accommodated adjacent to one another in the storage device housing. Insulating sleeves of mutually adjacent energy storage cells are clamped between storage cell housings of the adjacent energy storage cells.

The energy storage device may have a plurality of structurally separated storage modules, each of which contains a set of a plurality of the energy storage cells. Each storage module may be contained by a module housing. The module housing preferably has outer walls, which may be welded to one another. In particular, pressure plates that press the set of energy storage cells together (radially) may be provided as part of the module housing on two mutually opposite sides of the energy storage device along a circumference of the energy storage device. Correspondingly, the insulating sleeves of the energy storage cells may be radially prestressed in their installation position in the storage module.

The pressure plates may be connected to one another by means of side walls of the module housing. The pressure plates and the side walls may in this case be joined firmly to one another, in particular welded to one another. When the energy storage cells of the storage module are prismatic cells, the pressure plates are preferably aligned parallel to the main planes of the energy storage cells. Advantageously, the swelling forces of the energy storage cells therefore act substantially perpendicularly to the pressure plates and to the main surfaces of the insulating sleeve. When the energy storage cells are not grouped in storage modules, i.e. the energy storage cells are mounted directly in the storage device housing, the comment above relating to a storage module applies similarly for the entire energy storage device. In this case, the storage device housing thus replaces the module housing.

The motor vehicle proposed here may in particular be an aircraft, watercraft or ground vehicle. The motor vehicle is preferably an automobile or a commercial vehicle. The motor vehicle has an energy storage device as described above. The energy storage device is preferably configured as a flat storage device. It may in particular be arranged between two adjacent axes of the motor vehicle in the underfloor region of the motor vehicle.

The method proposed here is intended for the production of an energy storage cell, in particular the energy storage cell as described in detail above, and comprises the steps: providing the storage cell housing; arranging the electrode assembly and the electrolyte in the inner region of the storage cell housing; and applying the insulating sleeve on an outer circumferential surface of the storage cell housing, the storage cell housing being surrounded by the insulating sleeve at least in sections.

Preferably, the arranging of the electrode assembly in the inner region comprises stacking or winding the electrode assembly and inserting the stacked/wound electrode assembly into the storage cell housing. Preferentially, the step of applying the insulating sleeve is carried out before a step of forming the energy storage cell. Correspondingly, gases created in the inner region during the formation may be distributed uniformly in the inner region, particularly also in corner or edge portions of the inner region, by the pressing forces exerted by the insulating sleeve.

Any, in particular all, of the features described above in connection with the energy storage cell may be implemented in the energy storage device, in the vehicle and in the method for producing the energy storage cell.

Preferred embodiments of an energy storage cell, of an energy storage device, of a motor vehicle and of a method for producing an energy storage device will now be explained in more detail with reference to the appended schematic drawings.

### BRIEF DESCRIPTION OF THE DRAWINGS

The drawings may not be to scale, and:

FIG. 1 shows one variant of an energy storage cell in a longitudinal sectional view, the storage cell housing of the energy storage cell being in its unexpanded initial state;

FIG. 2 shows the energy storage cell of FIG. 1 in a longitudinal sectional view, the storage cell housing being expanded and the insulating sleeve being pressed together;

FIG. 3 shows a further variant of an energy storage cell in a longitudinal sectional view, in which the insulating sleeve has a portion that covers a bottom front surface of the storage cell housing, the storage cell housing being in its initial state;

FIG. 4 shows a further variant of an energy storage cell in a longitudinal sectional view, the insulating sleeve having cavities of different size when the storage cell housing is in its initial state;

FIG. 5 shows a further variant of an energy storage cell in a longitudinal sectional view, the insulating sleeve likewise having cavities of different size when the storage cell housing is in its initial state;

FIG. 6 shows a further variant of an energy storage cell in a longitudinal sectional view, the insulating sleeve having cavities of different size and the storage cell housing being in its initial state;

FIG. 7 shows a further variant of an energy storage cell in a longitudinal sectional view, differently configured cavities being provided on opposite sides of the storage cell housing;

FIG. 8 shows a storage module of an energy storage device comprising a plurality of energy storage cells according to FIG. 3, the energy storage cells touching one another via their insulating sleeves and the storage cell housings each being in their unexpanded initial state;

FIG. 9 shows the storage module of FIG. 8 after the storage cell housings have expanded;

FIG. 10 shows a storage module of a further energy storage device comprising a plurality of energy storage cells according to FIG. 4, the energy storage cells touching one another via their insulating sleeves and the storage cell housings each being in their unexpanded initial state;

FIG. 11 shows the storage module of FIG. 10 after the storage cell housings have expanded;

FIG. 12 shows one variant of a motor vehicle with the energy storage device, which has a plurality of storage modules; and

FIG. 13 shows one variant of a method for producing an energy storage cell.

### DETAILED DESCRIPTION OF THE DRAWINGS

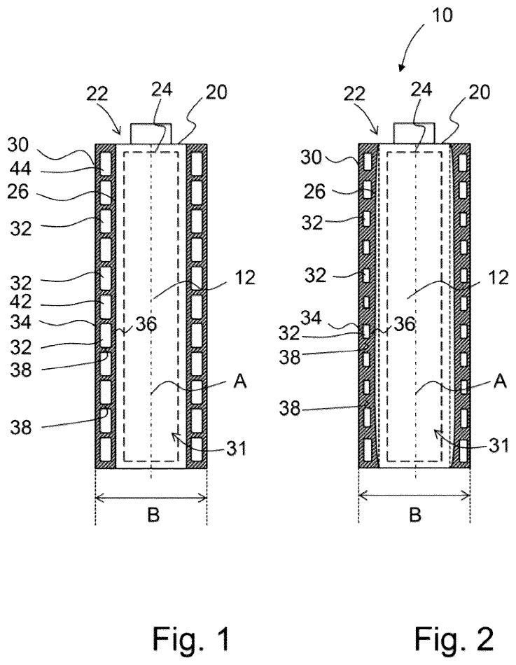

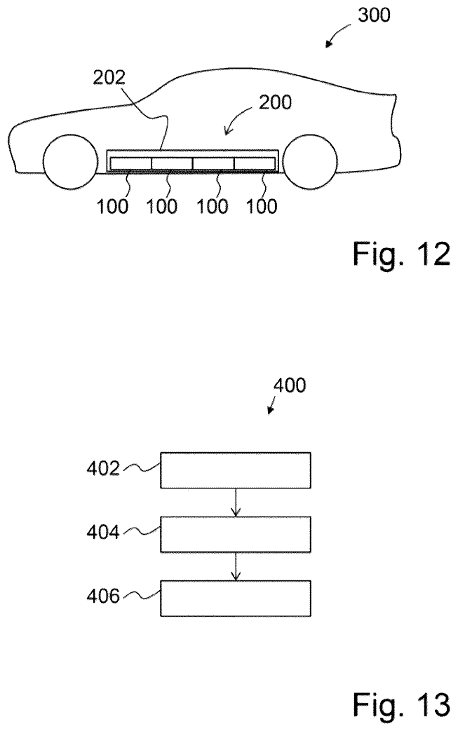

FIGS. 1 and 2 show an energy storage cell 10 which is intended for installation in an energy storage device 200 for a motor vehicle 300 as shown in FIG. 12 (here: an automobile). The energy storage cell 10 is configured here by way of example as a round cell and contains a storage cell housing 20 as well as an insulating sleeve 30 applied externally on the storage cell housing 20. The storage cell housing 20 bounds an inner region 22 of the energy storage cell 10, in which an electrode assembly 24 configured in this variant as an electrode winding or electrode stack is arranged. The inner region 22 furthermore contains an electrolyte, in particular a liquid electrolyte.

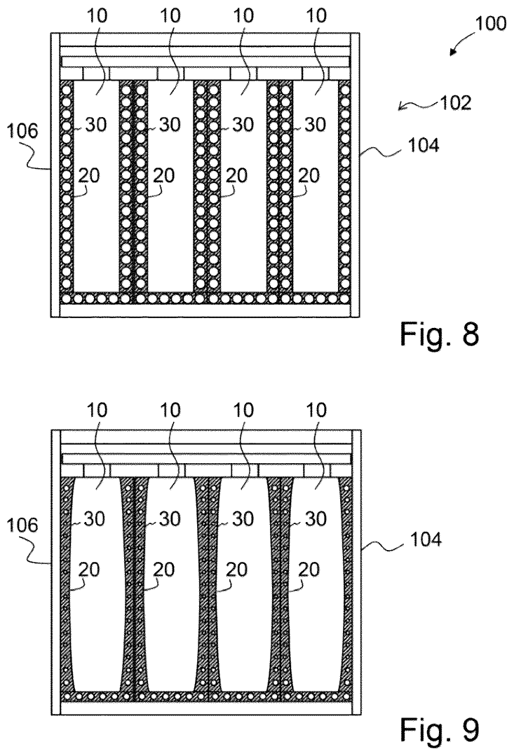

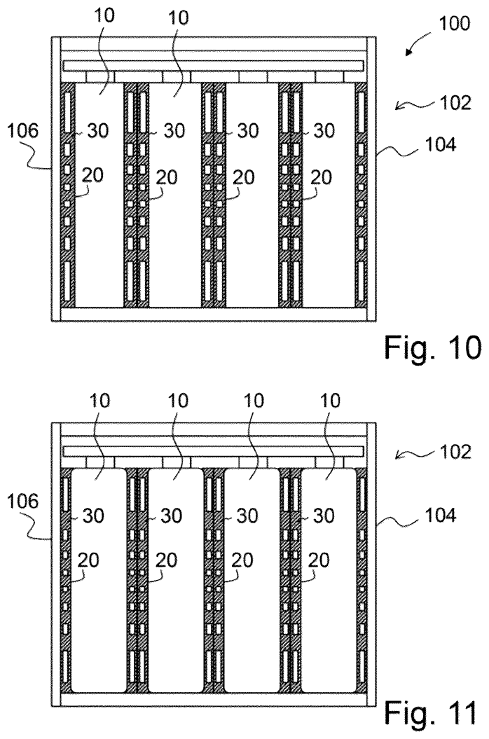

In the initial state of FIG. 1, the insulating sleeve 30 is at least 4 mm thick and externally surrounds the storage cell housing 20. In particular, the insulating sleeve 30 touches an outer circumferential surface 26 of the storage cell housing 20 with its entire inner circumferential surface at all times, i.e. both in the unexpanded initial state of the storage cell housing 20 shown in FIG. 1 and in the expanded state of the storage cell housing 20 shown in FIG. 2. The inner circumferential surface is therefore the same size as the outer circumferential surface 26. The storage cell housing 20 is therefore advantageously insulated on the entire outer circumferential surface 26. In the installation position of the energy storage cell 10 in the storage module 100 (cf. FIGS. 8 and 10) a width B (here: the outer diameter, cf. FIGS. 1 and 2) of the energy storage cell 10 remains substantially the same when the storage cell housing expands as described above.

The insulating sleeve 30 is formed so as to be elastically resilient, for example from rubber, and may therefore optionally be placed onto the storage cell housing 20 while being elastically prestressed radially. In addition, the insulating sleeve 30 may yield further when the storage cell housing 20 expands radially. In order to maintain a preestablished, fixed installation space for the energy storage cell in the energy storage device during the expansion of the storage cell housing, a plurality of cavities 32, 42, 44 are integrated in the insulating sleeve 30. In the initial state of the energy storage cell of FIG. 1, all cavities 32, 42, 44 are substantially equal in size (apart from slight manufacturing tolerances). A first cavity 42 is axially (in relation to the central longitudinal axis A of the energy storage cell 10) arranged centrally and a second cavity 44 is arranged on an axial edge/end of the insulating sleeve 30 and adjacent to a front surface of the energy storage cell 10. For the sake of clarity, only some of the cavities 32 are provided with reference signs. In the embodiment of FIG. 1, the cavities 32 are distributed uniformly over the insulating sleeve 30. In other words, a distance between two respectively adjacent cavities 32 is substantially the same for all cavities 32. Although only radially running webs 38 are shown in FIG. 1, the insulating sleeve 30 may additionally have axially running webs 38, which may intersect the radially running webs 38. Overall, there is thus a regular layout of cavities 32 that are arranged along the circumference of the storage cell housing and radially at the same distance from one another.

The cavities 32, the first cavity 42 and the second cavity 44 are bounded by a first layer 34 of the insulating sleeve 30 and a second layer 36 of the insulating sleeve 30. Formed between the first layer 34 and the second layer 36, there are webs 38 that connect the first layer 34 and the second layer 36 to one another and delimit respectively adjacent cavities 32 from one another. These webs 38 serve to stiffen the insulating sleeve 30. The webs 38 are (for radial forces) in addition stiffer than the first layer 34 and/or the second layer 36. For this purpose, the webs 38 may in particular be produced from a different, preferably stiffer material than the first layer 34 and/or the second layer 36.

In the embodiment of FIG. 1, the insulating sleeve 30 is connected cohesively to the outer circumferential surface 26 of the storage cell housing 20. In particular, the insulating sleeve 30 may be vulcanized onto the outer circumferential surface 26 by means of the second layer 36 by using a bonding agent. When, in another embodiment, the insulating sleeve 30 is configured as an inherently stiff sleeve body, the insulating sleeve may however be connected to the outer circumferential surface 26 with a form fit. In this case, a bonding agent is not necessary. Rather, the insulating sleeve 30 may in this case be provided with a compartment 31 for accommodating the storage cell housing 20, into which the storage cell housing 20 can be inserted. In addition, the storage cell housing 20 may then be removed from the compartment 31 without destroying the insulating sleeve 30.

When the storage cell housing 20 widens/expands (“swells”) in the installation position of the energy storage cell 10 in the storage module 100 (cf. FIG. 8) during the service life of the energy storage cell 10, in particular during a fast charging process, the axially central first cavity 42 may absorb more of the expansion and therefore may shrink more than the axially peripheral second cavity 44. The further a cavity 32 is away from the middle of the energy storage cell 10, the more this cavity 32 shrinks due to the expansion of the storage cell housing 20 (cf. FIG. 2). If at least the first layer 34 is not gastight, during this process gas, in particular air, may be expelled from the first cavity 42, the second cavity 44 and the other cavities 32. If the first layer 34 and/or the second layer 36 is gastight, however, the gas may at least partially remain in the aforementioned cavities 42, 44, 32 and be compressed. The insulating sleeve 30 therefore advantageously acts as a gas pressure spring. During contraction of the storage cell housing 20 in the charging/discharging cycles, the insulating sleeve 30 (and therefore also the at least one cavity) can expand correspondingly in terms of volume.

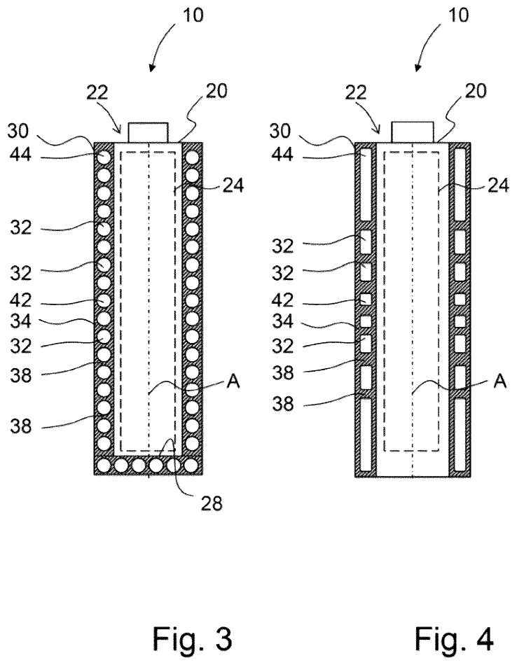

An energy storage cell 10 as shown in FIG. 3 therefore differs from the energy storage cell 10 of FIG. 1 in that the cavities 32 as well as the first cavity 42 and the second cavity 44 are configured to be round, substantially spherical. Furthermore, the insulating sleeve 30 additionally has an end portion that extends over a radially running front face 28 (here on the bottom) of the energy storage cell 10. The connection between the front face 28 and the insulating sleeve 30 is configured like the connection between the outer circumferential surface 26 and the insulating sleeve 30. Like the insulating sleeve 30 of FIG. 1, the insulating sleeve 30 of FIG. 3 may be configured without joints (monolithically).

Cavities 32 formed in the end portion preferably have the same properties as the other cavities 32 formed in the part of the insulating sleeve 30 adjacent to the outer circumferential surface 26. The insulating sleeve may thus be configured in such a way that, when the storage cell housing 20 expands axially, the cavities 32 in the end portion shrink in order to provide more room for the expansion of the storage cell housing 20. This can counteract expulsion of the energy storage cell 10 from a module housing 102 (explained in more detail below) due to the widening of the energy storage cell 10 when the energy storage cell 10 bears with the end portion on a bottom of the module housing 102 and is radially clamped. In other regards, the energy storage cell 10 of FIG. 3 has all features of the energy storage cell 10 of FIG. 1.

A further energy storage cell 10 of FIG. 4 differs from the energy storage cell 10 of FIG. 1 in that, as seen in the longitudinal section of FIG. 4 containing the central longitudinal axis A, the axially central first cavity 42 is smaller than the axially lateral second cavity 44. Further cavities 32 between the first cavity 42 and the second cavity 44 are distinguished by an internal volume that increases with the distance from the middle of the energy storage cell 10. Correspondingly, the insulating sleeve 30 can absorb less of the expansion of the storage cell housing axially in the middle than at the axial ends. Gas formed during a charging process is consequently distributed better in the inner region 22. This effect is synergistically enhanced by the distance between adjacent webs 38 being smaller in the region of the first cavity 42, so that the stiffness of the insulating sleeve 30 is higher in this region.

Additionally, the webs bounding the first cavity 42 may be configured to be stiffer than the webs 38 bounding the second cavity 44. The longitudinal section of the energy storage cell 10 in FIG. 4 may be repeated at predetermined rotation angles about the central longitudinal axis A. That is to say, cavities 32 adjacent to one another in the circumferential direction may be substantially equal in size in a similar way to the embodiment of FIG. 1. In other regards, the energy storage cell 10 of FIG. 4 has all features of the energy storage cell 10 of FIG. 1.

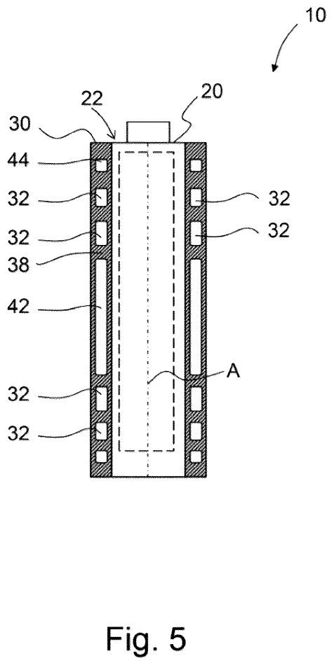

Yet another energy storage cell 10, which is shown in FIG. 5, differs from the energy storage cell 10 of FIG. 4 in that, as seen in the longitudinal section containing the central longitudinal axis A, the axially central first cavity 42 is larger than the axially lateral second cavity 44. Further cavities 32 between the first cavity 42 and the second cavity 44 are distinguished by an internal volume that decreases with the distance from the middle of the energy storage cell 10. Correspondingly, the insulating sleeve 30 can absorb more of the expansion of the storage cell housing axially in the middle than at the axial ends. In this variant as well, the longitudinal section of the energy storage cell 10 may be repeated at predetermined rotation angles about the central longitudinal axis A. That is to say, cavities 32, 42, 44 adjacent to one another in the circumferential direction may be substantially equal in size in a similar way to the embodiment of FIG. 1. In other regards, the energy storage cell 10 of FIG. 5 has all features of the energy storage cell 10 of FIG. 4.

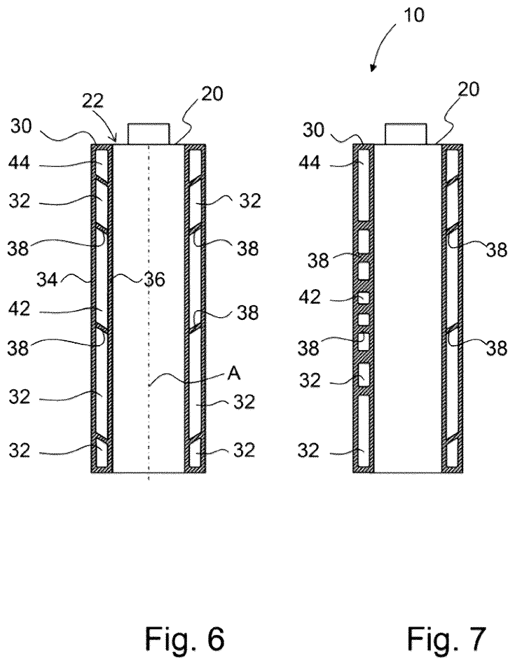

Further energy storage cells 10 are represented in FIGS. 6 and 7. The energy storage cell 10 of FIG. 6 differs from the energy storage cell 10 of FIG. 4 in that the latter axially has a larger number of rows of cavities than the former. While the energy storage cell 10 of FIG. 4 has by way of example eight rows of cavities extending along the circumference of the energy storage cell 10, the energy storage cell 10 of FIG. 6 has only five rows of cavities. In this way, the number of webs 38 may be reduced so that the storage cell housing 20 can ultimately have more installation space available for expansion. So that the insulating sleeve 30 at the same time has a high stability, some or all webs 38 may be produced from a different, in particular stiffer material than the first layer 34 and/or the second layer 36. For example, webs 38 consisting of thermoplastic or thermosetting material may be provided.

In the further embodiment of FIG. 7, the insulating sleeve 30 contains a first part in the circumferential direction, which is configured like the insulating sleeve 30 of FIG. 4, and a second part in the circumferential direction, which is configured like the insulating sleeve 30 of FIG. 6. In this way, even asymmetrical portions of a storage module 100 may be employed efficiently in terms of installation space with improved force distribution. In other regards, the energy storage cells 10 of FIGS. 6 and 7 have all features of the energy storage cell 10 of FIG. 4.

The storage module 100 represented in FIGS. 8 and 9 contains a module housing 102 and a plurality of energy storage cells 10 according to FIG. 3. The energy storage cells 10 are accommodated in the module housing 102. The insulating sleeves 30 of mutually adjacent energy storage cells 10 are clamped between storage cell housings 20 of the adjacent energy storage cells 10. Instead of the energy storage cells 10 of FIG. 3, another of the energy storage cells 10 described here as well as combinations of various of these energy storage cells 10 may also be accommodated in the module housing 102.

As represented in FIGS. 8 and 9, the module housing 102 is substantially rigid and defines an installation space for all the energy storage cells 10. FIG. 8 shows the storage module 100 in its initial state, in which the energy storage cells 10 are inserted into the module housing 102 directly after formation. Preferably, the energy storage cells 10 are clamped in the module housing 102 with a force fit under the prestress of the insulating sleeve 30, although other types of connection may also be envisioned. Each energy storage cell 10 occupies an installation space assigned to it in the storage cell housing 20 and is in its initial state, in which the respective storage cell housings 20 are likewise in their initial state.

The module housing 102 may form a frame that encloses a set of energy storage cells 10. On mutually opposite end sides, this frame has pressure plates 104, 106 which may be connected to one another via side walls (not shown). The pressure plates 104, 106 and the side walls are in this case adhesively bonded and/or welded to one another.

The insulating sleeve 30 of each energy storage cell 10 allows swelling of the associated storage cell housing 20 by reducing the volume that it occupies itself in the module housing 102. The cavities 32 as well as the first cavity 42 and the second cavity 44 shrink commensurately more when there is a smaller distance between the respective cavity 32, 42, 44 and the middle of the associated energy storage cell 10. As represented in FIG. 9, the insulating sleeves 30 therefore cushion the radial swelling forces emanating from the storage cell housing 20. A tensile stress of the storage cell housing 20, and in particular of the welding/adhesive bonding seams between the pressure plates 104, 106 and the side walls, may thereby be reduced. When the storage cell housing 20 contracts again (cf. transition from FIG. 9 to FIG. 8), the insulating sleeve 30 and the cavities 32, 42, 44 widen elastically.

A further storage module 100 of FIGS. 10 and 11 contains energy storage cells 10 according to FIG. 4. As represented in these figures, the effect of the smaller, axially central first cavities 42 during the swelling is that less space is available axially centrally for the swelling storage cell housing 20 than at the axial ends of the energy storage cells 10. Consequently, the gas is distributed better in the inner region. In other regards, the storage module 100 of FIG. 10 has the same features as the storage module 100 of FIG. 8.

The motor vehicle 300 represented in FIG. 12 has an energy storage device 200 that contains a plurality of energy storage modules 100 according to FIG. 8 or FIG. 10. The energy storage device 200 has a storage device housing 202 in which the energy storage modules 100 are fastened.

Each of the energy storage cells 10 described above may be produced using a production method 400 which is represented very schematically in FIG. 13. In a first step 402, the preferably empty (metallic) storage cell housing 20 is provided. The electrode assembly 24 may be produced in a further step (not represented) by winding or stacking.

Subsequently, in a step 404, the electrode assembly 24 is arranged in the inner region 22 of the storage cell housing 20. In this step, the electrolyte is preferably also introduced into the inner region 22. The storage cell housing 20 may then be closed (except for a degassing hole).

In the next step 406, the insulating sleeve 30 may be applied on an outer circumferential surface 26 of the storage cell housing 20. This will may involve producing the insulating sleeve 30 separately from the energy storage cell 10, for example using an injection molding method, and fixing it axially onto the storage cell housing 20. The insulating sleeve 30 may in this case be prestressed at least radially. Alternatively, the insulating sleeve 30 may be formed directly on the outer circumferential surface 26. The second layer 36 together with the webs 38 may in this case initially be molded on the outer circumferential surface 26, and optionally on one or both front surfaces on one side of the storage cell housing 20, in particular the front surface 28. Place holders for the cavities 32 as well as the first cavity 42 and the second cavity 44 may in this case be overmolded.

After the place holders have been removed, the outer first layer 34 may be formed on the webs 38. In this way, the storage cell housing 20 is surrounded by the insulating sleeve 30. Formation and/or degassing processes are preferentially carried out for improved gas distribution after the energy storage cell 10 has been provided with the insulating sleeve 30. The degassing hole may subsequently be closed. In order to produce the storage module 100, a module housing 102 may be provided and the energy storage cells 10 may be fixed in the module housing 102 under the radial prestress of the insulating sleeves 30.

The mounting of the energy storage cells 10 may take place with force regulation to a predetermined radial force that acts between the pressure plates 104, 106. The storage modules 100 may then be mounted in the energy storage device 200. Alternatively, the energy storage cells 10 may be inserted directly into the storage device housing 202.

For reasons of readability, the expression “at least one” is sometimes omitted in this disclosure for simplicity. If a feature is described in the singular or indefinitely (for example the/a cavity, etc.), its plural is also disclosed at the same time (for example the at least one cavity, i.e. the one cavity or the plurality of cavities). At least in sections in the present case means in sections or fully. The term “substantially” in the context of this disclosure respectively includes the precise property or precise value and deviations that are insignificant for the function of the property/value, for example due to production tolerances.

The preceding description of the present invention serves only for illustrative purposes and not for the purpose of restricting the invention. Various changes and modifications are possible in the framework of the invention without departing from the scope of the invention and of its equivalents.

1-14. (canceled)

15. An energy storage cell for a motor vehicle energy storage device, the energy storage cell comprising:
a storage cell housing defining an inner region;
an electrode assembly and an electrolyte in the inner region; and
an insulating sleeve on an outer circumferential surface of the storage cell housing and at least partially surrounding the storage cell housing, the insulating sleeve being at least partly elastic and including at least one cavity.

16. The energy storage cell according to claim 15,
wherein the insulating sleeve has a plurality of layers between which the at least one cavity is disposed.

17. The energy storage cell according to claim 16,
wherein the at least one cavity is bounded by at least one web connecting the layers to one another.

18. The energy storage cell according to claim 17,
wherein the at least one web is stiffer than at least one of the layers.

19. The energy storage cell according to claim 15,
wherein the at least one cavity is adapted to shrink when the storage cell housing expands.

20. The energy storage cell according to claim 15,
wherein the at least one cavity comprises a plurality of cavities.

21. The energy storage cell according to claim 20, wherein the plurality of cavities are substantially equal in size.

22. The energy storage cell according to claim 20, wherein the plurality of cavities are distributed at equal distances over the insulating sleeve.

23. The energy storage cell according to claim 15,
wherein the at least one cavity comprises a first cavity arranged adjacent to a middle of the energy storage cell and a second cavity smaller than the first cavity at an end of the insulating sleeve.

24. The energy storage cell according to claim 15,
wherein the insulating sleeve is adhesively bonded to or vulcanized on the storage cell housing.

25. The energy storage cell according to claim 15,
wherein the insulating sleeve is configured as a sleeve body having a thickness of at least 4.5 mm.

26. The energy storage cell according to claim 25,
wherein the sleeve body has a compartment in which the storage cell housing is accommodated.

27. The energy storage cell according to claim 15,
wherein the insulating sleeve is not gastight, at least in regions thereof.

28. The energy storage cell according to claim 15,
wherein the insulating sleeve comprises an elastic material.

29. The energy storage cell according to claim 28,
wherein the elastic material comprises an elastomer, a thermoplastic elastomer, a rubber and/or a chloroprene rubber.

30. An energy storage device for a motor vehicle, the energy storage device comprising:
a storage device housing; and
a plurality of the energy storage cells according to claim 15,
wherein the energy storage cells are accommodated in the storage device housing, and
wherein insulating sleeves of mutually adjacent energy storage cells are clamped between storage cell housings of adjacent energy storage cells.

31. A motor vehicle comprising the energy storage device according to claim 30.

32. A method for producing an energy storage cell, the method comprising:
providing a storage cell housing;
arranging an electrode assembly and electrolyte in an inner region of the storage cell housing; and
applying an insulating sleeve on an outer circumferential surface of the storage cell housing, the storage cell housing being at least partly surrounded by the insulating sleeve.
